(19) United States
(12) Patent Application Publication
(10) Pub. No.: US 2018/0203907 A1
(43) Pub. Date: Jul. 19, 2018

(54) METHOD AND SYSTEM FOR QUERYING SEMANTIC INFORMATION STORED ACROSS SEVERAL SEMANTICALLY ENHANCED RESOURCES OF A RESOURCE STRUCTURE

(71) Applicant: NEC EUROPE LTD., Heidelberg (DE)

(72) Inventor: Martin Bauer, Eppelheim (DE)

(21) Appl. No.: 15/745,720

(22) PCT Filed: Sep. 4, 2015
(86) PCT No.: PCT/EP2015/070245

§ 371 Date: Jan. 18, 2018

(30) Foreign Application Priority Data
Jul. 20, 2015 (EP) 15177551.7

(51) Int. Cl. G06F 17/30; H04W 4/70

(52) U.S. Cl. CPC G06F 17/30545; G06F 17/3048; H04W 4/70; G06F 17/30958; G06F 17/30604; G06F 17/30404

(57) ABSTRACT

A method for querying semantic information stored across several semantically enhanced resources of a resource structure includes: accessing, by a querying entity, a first semantically enhanced resource of the resource structure, wherein a first semantic description is associated with the first semantically enhanced resource; loading the first semantic description into a memory; analyzing the first semantic description; and loading, into the memory, a second semantic description associated with a second semantically enhanced resource of the resource structure. If a semantic element of the first semantic description contains a resource link, the resource link pointing to the second semantically enhanced resource.

### CROSS REFERENCE TO RELATED APPLICATIONS

This application is a U.S. National Stage Application under 35 U.S.C. § 371 of International Application No. PCT/EP2015/070245 filed on Sep. 4, 2015, and claims benefit to European Patent Application No. EP 15177551.1, filed on Jul. 20, 2015, which is incorporated by reference herein. The International Application was published in English on Jan. 26, 2017 as WO 2017/012678 A1 under PCT Article 21(2).

### FIELD

The present invention relates to a method for querying semantic information stored across several semantically enhanced resources of a resource structure, particularly for a machine-to-machine application, wherein a semantic description is associated with each of the semantically enhanced resources.

The present invention further relates to a querying entity for querying semantic information stored across several semantically enhanced resources of a resource structure.

The present invention further relates to a method for generating a resources structure.

The present invention additionally relates to a database for enabling queries regarding semantic information stored across several semantically enhanced resources of a resource structure, particularly at a machine-to-machine application.

The present invention also relates to a non-transitory computer readable medium storing a program causing a computer to execute a process.

### BACKGROUND

Machine-to-machine applications are gaining more and more importance nowadays leading to standards like ETSI M2M, oneM2M or the like. Conventional machine-to-machine systems provide well defined machine-to-machine resources to represent things of the real world in electronic form. A resource structure is formed by several to many resources and interconnections between them and describes the structure of a system, e.g. a sensor system or an air conditioning system.

oneM2M is a REST (Representational State Transfer)-based architecture. oneM2M enables applications to create resource structures for exchanging information using a number of pre-defined types, e.g. <AE>for representing oneM2M Application Entities, <Container> for storing content and sub-containers, <contentInstance> for storing content, e.g. measurements. Access rights are handled on a resource basis, i.e. fine-grained policies are possible

In order to provide consistent data translation and data interoperability to hetero-geneous machine-to-machine applications, some standards provide the possibility to add semantic information to resources. This document refers to such machine-to-machine resources with associated semantic description as semantically enhanced resources.

At oneM2M, semantic descriptions will be supported in the upcoming Release 2. In the current draft version, support for semantic descriptions is provided for <AE> (Application Entity), <Container> and <contentInstance> resources as well as <node> and <group>. The semantic description is stored in <SemanticDescription> child resources. Besides that, semantically enhanced functionality is provided making use of this semantic information, in particular semantic filtering or other semantic querying capabilities.

One drawback of the structure of oneM2M is that semantic queries, particularly semantic filtering, has to be performed on resource basis, i.e. a semantic query can only cover semantic information that is stored within one resource. As a result, a resource has to contain each piece of semantic information that is needed for a potential query/filter operation, even if the semantic information is not directly linked to the respective resource but to another resource of the resource structure. This will result in duplicated semantic information at different resources and increases the need of storage space considerably. Additionally, consistency of the duplicated semantic information has to be ensured, i.e. each time a piece of semantic information is changed, each semantically enhanced resource has to be checked, whether an update operation is needed or not. This results in high load to the system during an update process. Correct functioning of the update process is particularly critical in multi-user systems, where the changed piece of information may refer to the access rights of a querying entity. If the update process does not reliably change the data a user may access a piece of semantic information although the access right to this piece of semantic information is already revoked.

### SUMMARY

In an embodiment, the present invention provides a method for querying semantic information stored across several semantically enhanced resources of a resource structure, wherein a semantic description is associated with each of the semantically enhanced resources. The method includes: accessing, by a querying entity, a first semantically enhanced resource of the resource structure, wherein a first semantic description is associated with the first semantically enhanced resource; loading the first semantic description into a memory; analyzing the first semantic description; and loading, into the memory, a second semantic description associated with a second semantically enhanced resource of the resource structure. If a semantic element of the first semantic description contains a resource link, the resource link pointing to the second semantically enhanced resource.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a connection between a relation-semantic graph and an oneM2M resource structure;

FIG. 2 shows the semantic graph of FIG. 1 with regard to a possible filter operation;

FIG. 3 shows an example of a filter operation using a resource link according to an embodiment of the invention;

FIG. 4 shows an enlarged part of FIG. 3 showing the semantic graphs;

FIG. 5 shows another example of a filter operation using a resource link; and

FIG. 6 shows a further example of a filter operation using a resource link.

### DETAILED DESCRIPTION

As an alternative approach to duplication of semantic information, enhanced query/filter operations can be provided that allows for queries beyond resource borders. Then the enhanced querying entity/filter can be executed on several resources at the same time. In this case, semantic information can be kept to those resources to which the semantic information belongs. However, such an approach will have a deep impact to oneM2M, as these enhanced queries completely contradict the querying structure of oneM2M.

Although these problems are described in detail with regard to oneM2M, it is also present at other machine-to-machine systems or other resource-based systems that use semantic information.

Embodiments of the present invention provide methods and systems for querying semantic information as well as a querying entity and a database that may be used in connection with this method and/or system, where the semantic information is stored across several semantically enhanced resources of a resource structure, where the required storage space should be kept low and where the impact on a machine-to-machine system should be minimized.

In an embodiment, the invention provides a method for querying information stored across several semantically enhanced resources of a resource structure, particularly for a machine-to-machine application, wherein a semantic description is associated with each of the semantically enhanced resources, said method comprising the steps of: accessing a first semantically enhanced resource of the resource structure by a querying entity, wherein a first semantic description is associated with the first semantically enhanced resource, loading the first semantic description into a memory, analyzing the first semantic description, and loading into the memory a second semantic description associated with a second semantically enhanced resource of the resource structure, if a semantic element of the first semantic description contains a resource link, said resource link pointing to the second semantically enhanced resource.

In a further embodiment, the invention provides a querying entity for querying semantic information stored across several semantically enhanced resources of a resource structure, comprising: a memory for storing semantic descriptions, a control unit operable to access a first semantically enhanced resource and to load into the memory a first semantic description associated with the first semantically enhanced resource, and an analyzing unit operable to analyze the first semantic descriptions stored in the memory, wherein the control unit is additionally operable to access and load into the memory a second semantically enhanced resource, wherein a pointer to said second semantically enhanced resource—resource link—is contained in an element of the first semantic description.

In another embodiment, the invention provides a method for generating a resource structure comprising the steps of: analyzing a semantic structure representing a behavior of a system, extracting semantically enhanced resources contained in the semantic structure, generating, for each semantically enhanced resource, a semantic description as a subset of the semantic structure, wherein each semantic description contains nodes of the semantic structures associated with the respective semantically enhanced resource, generating a resource link between a first semantically enhanced resource and a second semantically enhanced resource, if a node of the semantic structure is contained in the first semantically enhanced resource and in the second semantically enhanced resource, said resource link preferably being implemented as a URL (Uniform Resource Locator) or a URI (Uniform Resource Identifier).

In yet another embodiment, the invention provides a database for enabling queries regarding semantic information stored across several semantically enhanced resources of a resource structure, particularly at machine-to-machine application, wherein the database comprises hierarchically structured resources, wherein the resources comprise at least two semantically enhanced resources, wherein a semantic description is associated to each of said semantically enhanced resources, respectively, and wherein at least one of the semantically enhanced resources comprises a resource link, said resource link pointing to another semantically enhanced resource.

In yet another embodiment, the invention provides a system for querying semantic information stored across several semantically enhanced resources of a resource structure, comprising: storage space storing a database according to one of the embodiments of this application, a querying entity and a user device operable to generate a query for the querying entity.

In yet another embodiment, the invention provides a non-transitory computer readable medium that stores a program causing a computer to execute a process comprising: accessing a first semantically enhanced resource of the resource structure, wherein a first semantic description is associated with the first semantically enhanced resource, loading the first semantic description, analyzing the first semantic description, and loading a second semantic description associated with a second semantically enhanced resource of the resource structure, if a semantic element of the first semantic description contains a resource link, said resource link pointing to the second semantically enhanced resource.

Although applicable to any kind of machine-to-machine application, at least one of the embodiments of this invention will be described with regard to oneM2M, particularly to Release 2 of oneM2M which is currently elaborated.

According to embodiments of the invention, semantic information can be distributed across several resources. To this end, each semantically enhanced resource is associated to a semantic description which contains one or several pieces of semantic information. The semantic information contained in a semantic description is substantially related to the associated resource. Association between a semantically enhanced resource and a semantic description may be established in different ways. Each kind of association that forms a kind of link between a semantically enhanced resource and a semantic description is suitable. The semantic description may be part of the semantically enhanced resource. It may be contained in a variable or a field of the resource. The semantic description may be incorporated into a sub-container or a child-resource that is linked to a superior container or a parent resource. The link may also be provided by the concept of features, where the semantic description is a feature that is linked to the resource.

According to embodiments of the invention, it is not necessary to duplicate substantial parts of the semantic information or to rework querying capabilities completely. Instead a resource link can be provided at each semantically enhanced resource which refers to semantic information which is not fully defined within its semantic description. A resource link is a kind of pointer that points from one resource description to another resource description. By following a resource link, the semantic information that is needed for a query can be retrieved without providing each needed piece of information within one resource description. By providing a resource link, a query may still be resource based, i.e. the query refers just to one resource. However, by following a resource link, semantic information may be distributed across several semantically enhanced resources. Therefore, not the complete querying concept has to be reworked. It is sufficient that the querying entities may follow a resource link and retrieve the required information from the linked semantic description.

The resource link may be provided by different elements. It might be a variable of the resource or of the semantic description. It might be a node of a tree that forms the semantic description. With regard to oneM2M, the resource link might be implemented as an oneM2M annotation.

According to one embodiment of the invention, a method for querying semantic information stored across several semantically enhanced resources may comprise the step of accessing a first semantically enhanced resource of a resource structure by a querying entity, wherein a first semantic description is associated with the first semantically enhanced description. The first semantically enhanced resource might be each semantically enhanced resource of the resource structure. The adjective “first” is only used to distinguish a semantically enhanced resource that contains a resource link (or the associated semantic description) from a semantically enhanced resource/semantic description to which the resource link points to second semantically enhanced resource/second semantic description. Even each second semantically enhanced resource might form a first semantically enhanced resource for a next step of the method.

The querying entity may be implemented by different means. It may be implemented by software and/or hardware. Preferably it is implemented by a program that runs on a processor, like a microprocessor, a DSP (Digital Signal Processor), a suitably configured FPGA (Field Programmable Gate Array), a vCPU (virtual Central Processing Unit) of a virtualization system or other processing units. The processor may be part of a computer, a server, a smartphone, a PDA (Personal Digital Assistant) or the like. The querying entity may be run on the same unit that stores the resource structure and/or the semantic descriptions. The querying entity may also run on a unit that does not store the resource structure and/or the semantic descriptions. In such a case, the query may be sent to the unit that stores the required data via a network, like the internet or a LAN (Local Area Network). The unit that stores the resource structure and/or the semantic descriptions may be implemented by a server or the like. However, the resource structure may also be stored on a distributed system with different nodes that are interconnected by a network, like the internet or a LAN. Each node of such a distributed system may store one or several resources of the resource structure and/or one or several semantic descriptions. In such a distributed system, the querying entity may access the first semantic description directly (if running at the node which stores the first semantic description) or via the network (if running on a different node than the node which stores the first semantic description). Such a distributed system may be formed by several servers or by a cloud system.

After accessing the first semantically enhanced resource, the first semantic description may be loaded into a memory. The memory may be implemented by various memory technologies. A rewriteable non-transitory memory may be used as well as a volatile memory. The non-transitory memory can be, but not limited to, a hard disk drive, a flash memory, a solid state disk, a USB memory stick or the like. The volatile memory may be a RAM (Random Access Memory). The memory may be part of or may be associated with the querying entity.

After loading the first semantic description, the first semantic description may be analyzed. The step of analyzing may search for a resource link that is contained in the first semantic description, wherein the resource link points to a second semantic description/a second semantically enhanced resource. If a resource link is found, the second semantic description may be loaded into the memory.

In one embodiment, the step of analyzing the first semantic description comprises the step of executing a query stored at the querying entity, wherein the step of loading a second semantic description is preformed preferably only, if the second semantic description is needed for the query. During the step of loading the second semantic description, the step of executing the query may be halted and may be resumed after the step of loading the second semantic description is terminated. As already mentioned above, each second semantic description may also form a first semantic description for another step of the method. According to one embodiment, the step of loading a second semantic description may be repeated each time, a resource link is found. I.e. if the second semantic description contains a resources link, this second semantic description will form a new first semantic description for the next step of loading a second semantic description. The new second semantic description for this next step will be the semantic description to which the resource link of the new first semantic description points to.

In another embodiment, the step of analyzing may comprise searching for each element of the first semantic description containing a resource link, wherein the step of loading a second semantic description is performed for each resource link which is found in the first semantic description, and wherein, after loading each second semantic description, a query stored at the querying entity is executed. In this embodiment, the second semantic description will be loaded, irrespective of the usage of the semantic description by a querying entity. Similar to the previously described embodiment, each second semantic description loaded into the memory may be analyzed regarding the presence of a resource link in one element of the semantic description. This resource link will point to another second semantically enhanced resource. Accessing a second semantic description and loading the second description into the memory may be repeated, until the semantic descriptions of each second semantically enhanced resource is loaded into the memory, thus loading a complete tree with each semantic description associated with the first semantic description. This approach has the advantage that a query can be executed on the semantic information, which is loaded from different semantically enhanced resources into the memory, and that the query does not need separate accesses to the semantically enhanced resources. This approach may reduce network load, particularly if the semantic information is needed for different queries regarding different querying criteria.

According to one embodiment, a right of the querying entity for accessing the second semantic description is checked before the second semantic description is loaded. This allows for fine-grained access policies. Each time a querying entity has the right to access the data, the second semantic description may be loaded into the memory. Each time the querying entity has not the right to access the data, the second semantic description will not be loaded. In this case, the query may terminate due to the lack of required data or the query may jump to the next element and protocol the terminated loading request.

Each of the semantic descriptions may comprise one or more triples, preferably RDF (Resource Description Framework) triples. Preferably, classes and properties are defined in OWL (Web Ontology Language). Each of these triples comprise a subject, an object and a predicate linking the subject and the object. When using such triples, the step of analyzing a semantic description may comprise following the links which are provided by the triples. In this case, the step of analyzing is more or less a search in a graph formed by the different triples.

In one embodiment, the querying entity may comprise a memory for storing semantic descriptions, a control unit and an analyzing unit. In most cases the control unit and the analyzing unit will be implemented by a program running on a processor as already mentioned before. The control unit may access a first semantically enhanced resource and load into the memory a first semantic description associated with the first semantically enhanced resource. The analyzing unit may analyze the first semantic description stored in the memory. The control unit may additionally access and load into the memory a second semantically enhanced resource/second semantic description, wherein a pointer to said second semantically enhanced resource resource link is contained in an element of the first semantic description.

In one embodiment, the querying entity may be a filter, wherein the filter preferably searches for semantically enhanced resources that fulfil a filter criteria stored at the querying entity.

In one embodiment, the querying entity is based on SPARQL (SPARQL Protocol And RDF Query Language).

In another embodiment, the memory for storing semantic description is operable as a cache memory that stores each loaded semantic description, preferably for a predefined time. The cache memory may not only have the combined information, but may also store the access rights information for subsequent evaluations. Together this may enable subsequent access to be much faster as the process of combining the graphs does not need to be executed. The cache may be regarded as being valid for a predefined time, e.g. for 1 hour, 10 minutes or 1 minute. If the predefined time is expired, the cache memory or the expired parts of it may be deleted.

In a further development of the cache memory, a cache invalidation entity is provided that checks the validity of the cache content and that may delete parts of the cache or the complete cache. There is a high likelihood that such a cache remains valid for a longer period as the semantic description usually captures (rather static) structural information. Cache invalidation can therefore be done on a time base with a suitable time period. Still there is a chance of an inconsistent state. Additional measures can be added to a system to avoid this. The following list provides three option that may be suitable measures and that may be combined with each other. Although described with regard to oneM2M, the measures may also be applied to other resource-based systems: (a) Introducing an additional query parameter which controls whether a query is allowed to be executed on a cached copy. This enables applications to control the use of that cache. If usage of the cached information is not allowed, the query may be executed on the original semantic descriptions and the cache may be refreshed or invalidated. (b) Introducing an additional query parameter which instructs an oneM2M system to keep the cache of the combined semantic description. Potentially, this parameter can contain a timeout or some other values defining when the cache shall be invalidated. These values may override any system internal cache invalidation parameters. (c) Introduction and use of a subscription to the semanticDescription resources and/or to access control information which fires in case the semanticDescription is changed. This can be internally used for invalidating a cached copy and to reach a consistent state fast.

If consistency is absolutely necessary, the oneM2M system can introduce a transaction for updating a master copy of the semantic description and all the cached copies where the semantic description is contained in.

According to one embodiment of a method for generating a resource structure, the method comprises the step of analyzing a semantic structure representing a behavior of a system. This analyzing step may comprise finding different semantically enhanced resources contained in the semantic structure.

In a next step semantically enhanced resources contained in the semantic structure may be extracted from the semantic structure. Further for each semantically enhanced resource, a semantic description may be generated as a subset of the semantic structure, wherein each semantic description contains nodes of the semantic structures associated with the respective semantically enhanced resource. If a node of the semantic structure is contained in two semantically enhanced resources, a resource link between a first semantically enhanced resource and a second semantically enhanced resource may be generated. The resource link may be implemented as a URL (Uniform Resource Locator) or a URI (Uniform Resource Identifier). As such a resource structure which is extracted from a semantic structure will contain semantically enhanced resources only, it might be possible to add resources that do not contain semantic descriptions, in order to describe system behavior more precisely. For adding these “standard” resources and/or for extracting the semantically enhanced resources, additional information about the internal structure of the described system may be provided.

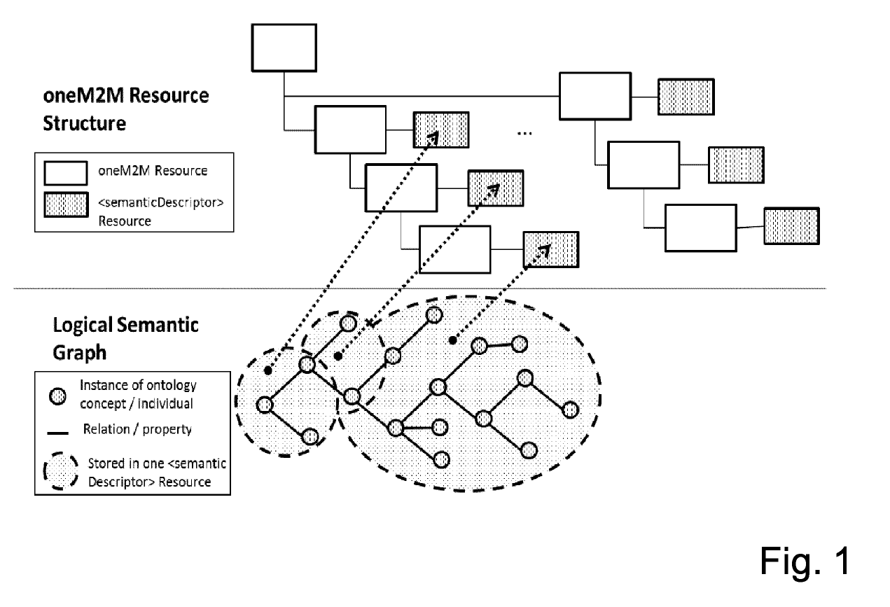

The upper part of FIG. 1 shows an oneM2M resource structure. Each resource is illustrated by a rectangular box. Each link between two resources is illustrated by a line. The base resource is formed by the resource which is illustrated at the uppermost position. The two or more resources connected to this base resource are child resources of the base resource. Each of these child resources forms a parent resource for at least one child resource that is linked to it. The child resources that contain the semantic descriptions are shown as boxes with a dotted surface and are <semanticDescriptor>resources.

The lower part of FIG. 1 shows a semantic graph. Each node is an instance of an ontology and represents a concept or individual. Each edge represents a relation or a property. The semantic tree forms the logical structure of the system. The nodes, which are stored in one semantically enhanced resource, are contained in a dotted line. Three dotted arrows shows the relation between the areas surrounded by a dotted line and the respective semantically enhanced resource. Nodes with an edge crossing the dotted line between two neighboring areas are contained in the two semantically enhanced resources which are represented by the area surrounded by the dotted line. For these nodes, a resource link is used in order to provide a pointer from one semantically enhanced resource to another semantically enhanced resource.

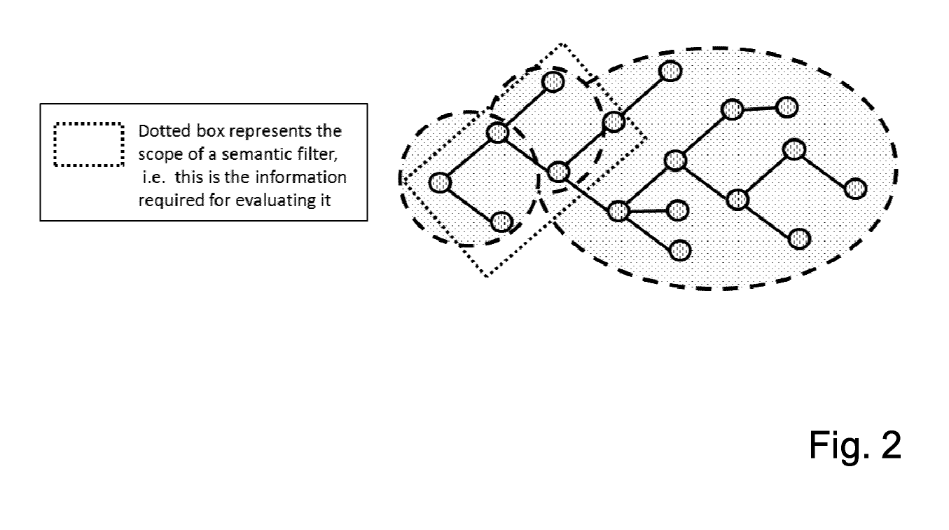

FIG. 2 shows an example for a filter operation which is dependent on the semantic description contained in two semantically enhanced resources. The dotted box represents the scope of such a filter, i.e. this is the information required for evaluating it.

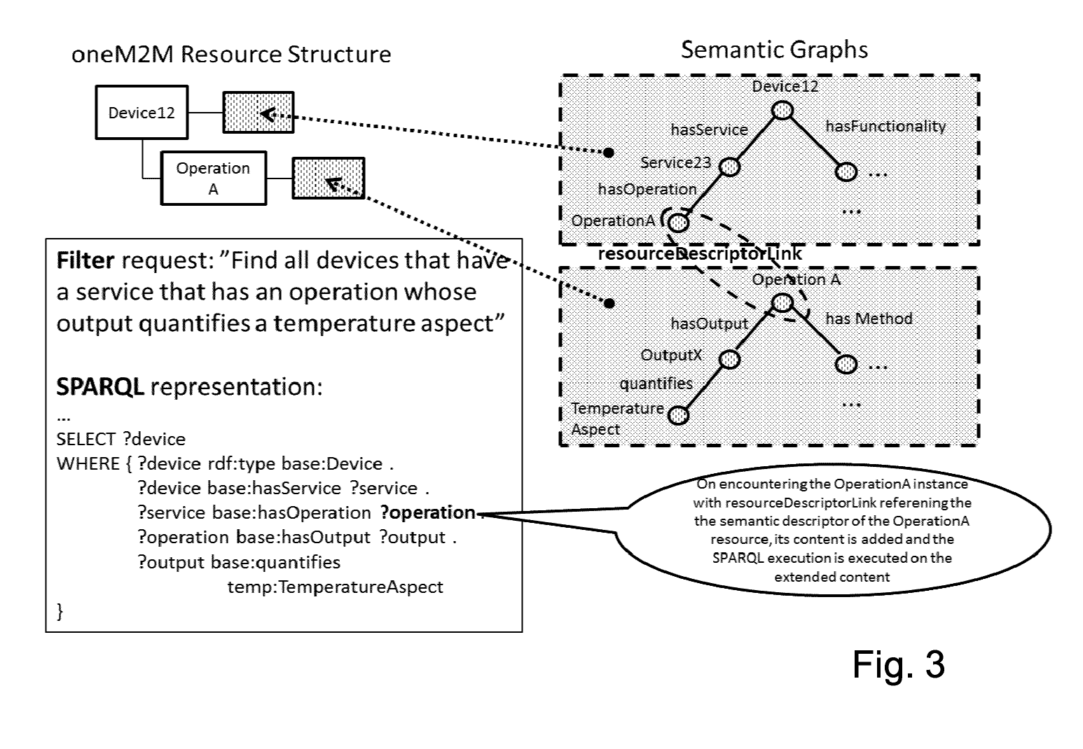

FIG. 3 shows such an example. The diagram on the upper left hand side shows the oneM2M resource structure. The two diagrams on the right hand side shows the semantic description of the two semantically enhanced resources. The resource link between the two semantic diagrams is represented by a dotted ellipse. The filter request and the SPARQL representation of this request is shown on the lower left hand side of FIG. 3.

The filter request is: “Find all devices that have a service that has an operation whose output quantifies a temperature aspect”. Its SPARQL representation is as follows:

SELECT ?device
WHERE { ?device rdf:type base:Device .
?device base:hasService ?service .

| | |
|---|---|
| ?service base:hasOperation ?operation . | |
| ?operation base:hasOutput ?output . | |
| ?output base:quantifies | temp:TemperatureAspect |
| } | |

When executing the filter request, the filter accesses “Device12” which forms a first semantically enhanced resource. The graph contained in “Device12” is a first semantic description. By following the edge “hasService” to node “Service23” and edge “hasOperation” to node “OperationA”, the filter reaches a resource link that is contained in node “OperationA” and that points to a second semantically enhanced resource and a second resource description. At this stage, execution of the filter operation will be halted until the required information are retrieved from the second semantically enhanced resource. By following this resource link, the semantic description which contains a definition of “OperationA” can be accessed. The second semantic description is loaded into the memory. After loading is completed, filter operation will be resumed. By following the edge “hasOutput” to node “OutputX” and edge “quantifies” to node “temperatureAspect”, the filter reached the information that “Device12” fulfills the filter request.

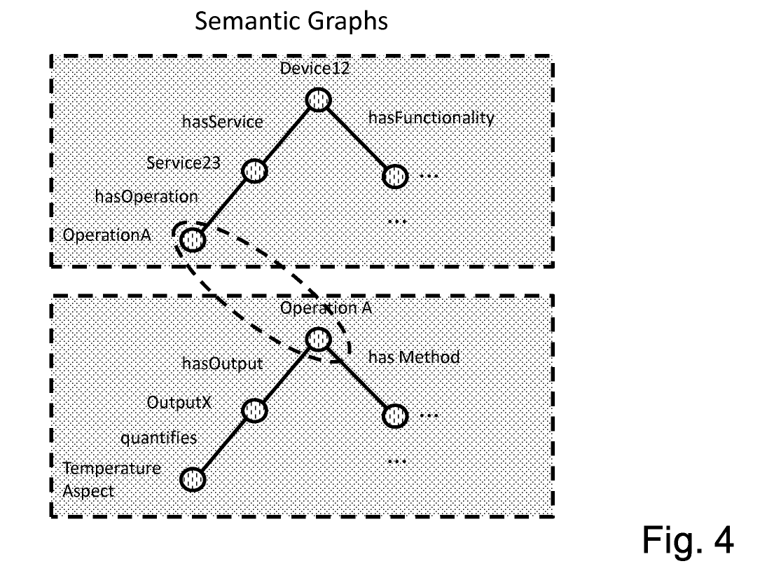

FIG. 4 shows an enlarged part of FIG. 3 showing the semantic graphs.

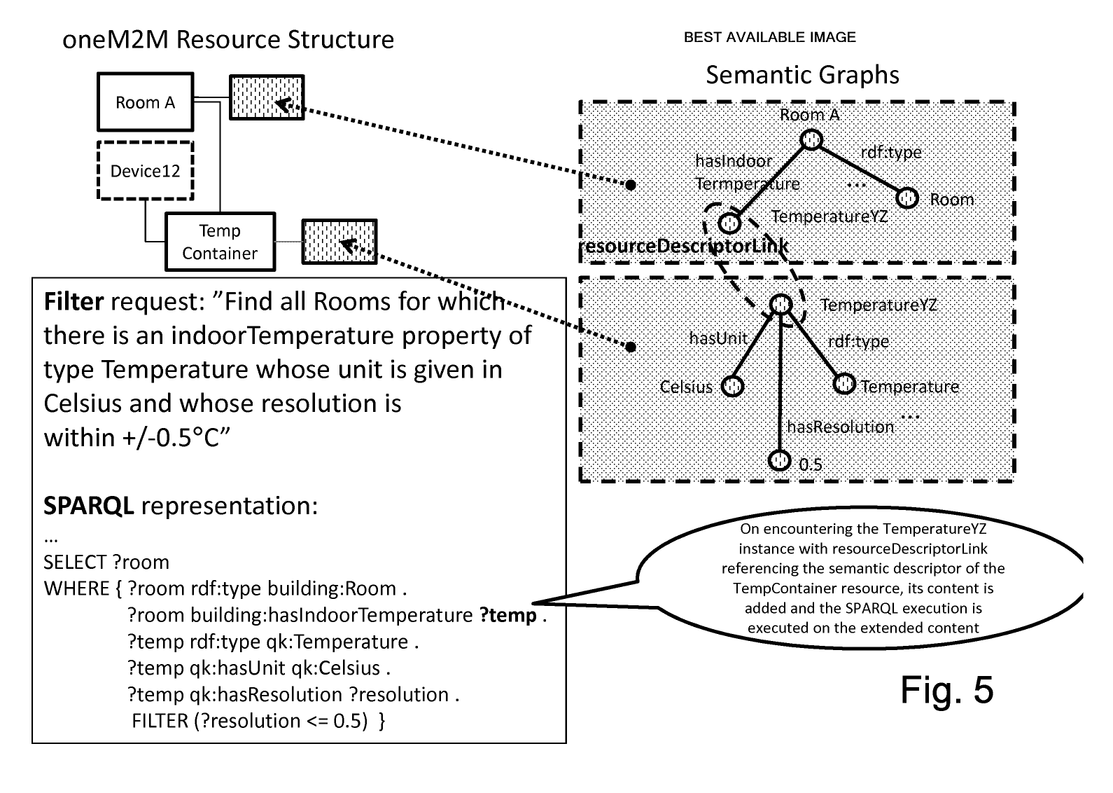

FIG. 5 shows another example for a filter operation. The basic composition of the figure is similar to FIG. 3. The filter request of this example is: “Find all Rooms for which there is an indoorTemperature property of type Temperature whose unit is given in Celsius and whose resolution is within +/−0.5° C”. Its SPARQL representation is:

```
SELECT ?room
WHERE { ?room rdf:type building:Room .
        ?room building:hasIndoorTemperature ?temp .
        ?temp rdf:type qk:Temperature .
        ?temp qk:hasUnit qk:Celsius .
        ?temp qk:hasResolution ?resolution .
FILTER (?resolution <= 0.5)
}
```

Staring at resource “RoomA”, the filter will follow the edge “haslndoor-Temperature” to node “TemperatureYZ”. This node contains a resource link to a second semantic description. By following the resource link and edge “hasResolution” (as specified in the filter request), the filter will reach “0.5”. As this resolution is <=0.5, this node fulfills the filter request.

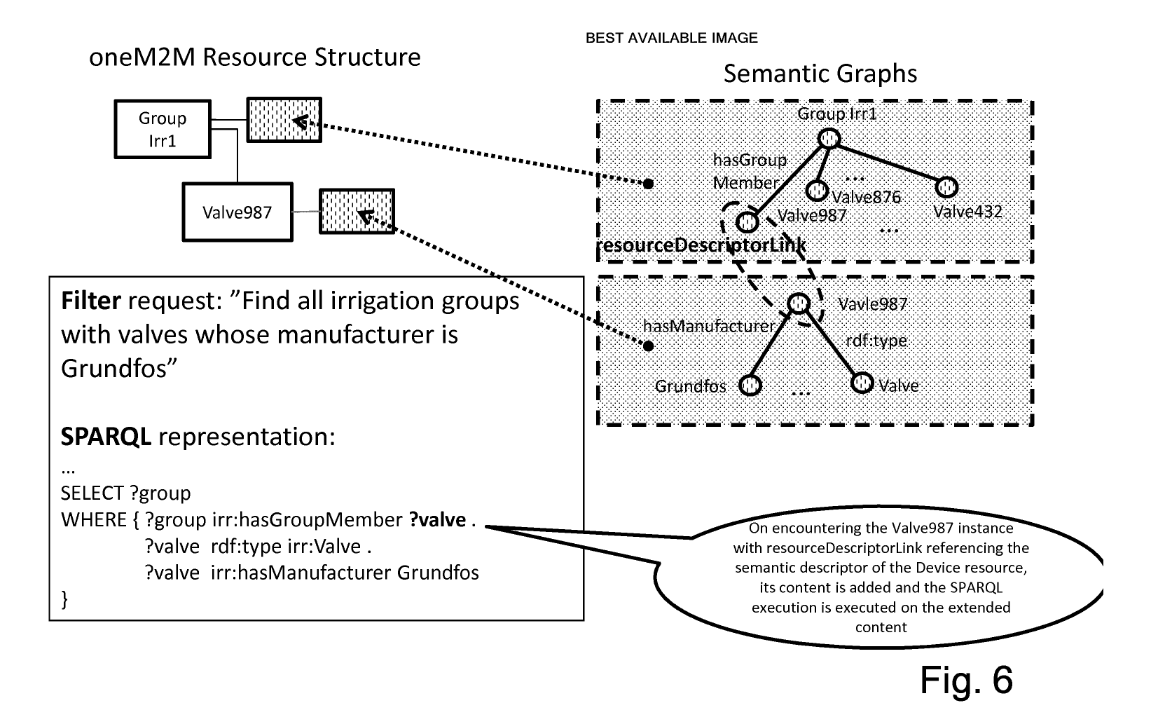

FIG. 6 shows a further example. In this example, the filter request is: “Find all irrigation groups with valves whose manufacturer is Grundfos”. The SPARQL representation is:

```
SELECT ?group
WHERE { ?group irr:hasGroupMember ?valve .
        ?valve rdf:type irr:Valve .
        ?valve irr:hasManufacturer Grundfos
}
```

In this case, node “Valve987” contains a resource link to a second semantic description. By following the edges of the first and second semantic description, the filter may evaluate, whether this resource fulfills the filter request.

The following list summarizes some embodiments of the invention as well as some benefits with reference to oneM2M, a SPARQL filtering engine and semantically enhanced resources implemented by semantic descriptor child resources:
The SPARQL filtering engine may be modified in the following way:
   The semantic filter formulated as a SPARQL request is executed on the content of the semantic descriptor resource of the candidate resource
   If in the course of the execution a class instance with one or more resourceDescriptorLink annotations is encountered, the execution is halted
   The content of each of the semantic descriptor resources the semanticDescriptorLink references is added to the content on which the SPARQL request is being executed (lazy evaluation, alternative: fetch everything before execution, but may result in fetching unnecessary information)
   The execution of the SPARQL request is continued on the enlarged content
System with semantically described REST resources, where
   relevant semantic description in semantic descriptor child resources is distributed across REST resources
   Annotation links connect the semantic information in semantic descriptor child resources with other semantic descriptor REST resources containing additional semantic information
Semantic operations may follow annotation links during their execution. Specifically operation can be a filtering operation, where resources are filtered according to semantic description.
Specifically operation can be a discovery operation, where resources are discovered based on semantic description.
During execution of semantic operations individual access rights on semantic descriptor resources may be respected.
Caching of semantic information as well as access rights can be used to make subsequent executions of operations on the same information more efficient.
Operations can have an explicit parameter to indicate that information should be cached for future use.
Operations can have an explicit parameter to indicate that cached information not older than a specified time can be used for evaluation.
Subscriptions on changes to semantic descriptor resources can be used for cache invalidation.
Subscriptions on changes to access control rights of semantic descriptor resources can be used for cache invalidation.
Transactions can be used to update semantic descriptions, updating/invalidating all cached copies consistently.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for querying semantic information stored across several semantically enhanced resources of a resource structure, wherein a semantic description is associated with each of the semantically enhanced resources, the method comprising:
accessing, by a querying entity a first semantically enhanced resource of the resource structure, wherein a first semantic description is associated with the first semantically enhanced resource,
loading the first semantic description into a memory,
analyzing the first semantic description, and
loading, into the memory, a second semantic description associated with a second semantically enhanced resource of the resource structure,
wherein a semantic element of the first semantic description contains a resource link, the resource link pointing to the second semantically enhanced resource.

2. The method according to claim 1, wherein analyzing the first semantic description comprises executing a query stored at the querying entity,
wherein the loading the second semantic description is preformed if the second semantic description is needed for the query, and
wherein during the loading the second semantic description, the executing the query is halted and is resumed after the loading the second semantic description is terminated.

3. The method according to claim 1, wherein the analyzing the first semantic description comprises searching for each clement of the first semantic description containing a resource link,
wherein the loading the second semantic description is performed for each resource link which is found in the first semantic description, and
wherein, after the loading each second semantic description, a query stored at the querying entity is executed.

4. The method according to claim 3, wherein each second semantic description loaded into the memory is analyzed regarding the presence of a resource link in one element of the semantic description, the resource link pointing to another second semantically enhanced resource, and -wherein the semantic descriptions of each second semantically enhanced resource are loaded into the memory, thus loading a complete tree with each semantic description associated with the first semantic description,

5. The method according to claim 1, wherein, before loading the second semantic description, a right of the querying entity for accessing the second semantic description is checked.

6. The method according to claim 1, wherein each semantic description comprises one or more triples, each of the triples comprising a subject, an object, and a predicate linking the subject and the object, and
wherein the analyzing a semantic description comprises following the links which are provided by the triples,

7. A querying entity for querying semantic information stored across several semantically enhanced resources of a resource structure, the querying entity comprising:
a memory for storing semantic descriptions,
a control unit operable to access a first semantically enhanced resource and to load into the memory a first semantic description associated with the first semantically enhanced resource, and
an analyzing unit operable to analyze the first semantic description stored in the memory,
wherein the control unit is additionally operable to access and load into the memory a second semantically enhanced resource, wherein resource link—is contained in an element of the first semantic description,
wherein the resource link is a pointer to the second semantically enhanced resource.

8. The querying entity according to claim 7, wherein the querying entity is a filter, wherein the filter searches for semantically enhanced resources that fulfill a filter criteria stored at the querying entity.

9. The querying entity according to claim 7, wherein the querying entity is based on SPARQL (SPARQL Protocol And RDF Query. Language).

10. The querying entity according to claim 7, wherein the memory is operable as a cache memory that stores each loaded semantic description.

11. A method for generating a resource structure, the method comprising:
analyzing a semantic structure representing a behavior of a system;
extracting semantically enhanced resources contained in the semantic structure;
generating, for each semantically enhanced resource, a semantic description as a subset of the semantic structure, wherein each semantic description contains nodes of the semantic structures associated with the respective semantically enhanced resource; and
generating a resource link between a first semantically enhanced resource and a second semantically enhanced resource, if a node of the semantic structure is contained in the first semantically enhanced resource and in the second semantically enhanced resource.

12. The method according to claim 11, wherein each semantic description is generated as an element, of a respective semantically enhanced resource, or wherein a semantic description is generated as a property which is linked to a respective semantically enhanced resource.

13. A database for enabling queries regarding semantic information stored across several semantically enhanced resources of a resource structure, the database comprising:
hierarchically structured resources, wherein the resources comprise at least two semantically enhanced resources, wherein a semantic description is associated with each of the at least two semantically enhanced resources, and wherein at least one of the semantically enhanced resources comprises a resource link, the resource link pointing from one semantically enhanced resource to another semantically enhanced resource.

14. A system for querying semantic information stored across several semantically enhanced resources of a resource structure, the system comprising:
storage space storing a database the database comprising hierarchically structured resources, wherein the resources comprise at least two semantically enhanced resources, wherein a semantic description is associated with each of the at least two semantically enhanced resources, and wherein at least one of the semantically enhanced resources comprises a resource link the resource link pointing from one semantically enhanced resource to another semantically enhanced resource;
a querying entity for querying semantic information stored across several semantically enhanced resources of a resource structure, the querying entity comprising:
a memory for storing semantic descriptions,
a control unit operable to access a first semantically enhanced resource and to load into the memory a first semantic description associated with the first semantically enhanced resource, and
an analyzing unit operable to analyze the first semantic description stored in the memory; and
a user device operable to generate a query for the querying entity,
wherein the control unit is additionally operable to access and load into the memory a second semantically enhanced resource, and
wherein resource link is contained in an element of the first semantic description, wherein the resource link is a pointer to the second semantically enhanced resource.

15. A non-transitory computer readable medium storing a program causing a computer to execute a process, the process comprising:
accessing a first semantically enhanced resource of the resource structure, wherein a first semantic description is associated with the first semantically enhanced resource;
loading the first semantic description;
analyzing the first semantic description; and
loading a second semantic description associated with a second semantically enhanced resource of the resource structure,
wherein a semantic element of the first semantic description contains a resource link, the resource link pointing to the second semantically enhanced resource.
